(19) United States
(12) Patent Application Publication
(10) Pub. No.: US 2026/0149781 A1
(43) Pub. Date: May 28, 2026

(54) COVERAGE CLASS SETUP

(71) Applicant: Hewlett-Packard Development Company, L.P., Spring, TX (US)

(72) Inventors: Mokhwa LIM, Seongnam Si (KR); Sunyoung PARK, Seongnam Si (KR)

(21) Appl. No.: 19/121,544

(22) PCT Filed: Apr. 18, 2023
(86) PCT No.: PCT/US2023/018901

§ 371 Date: Apr. 16, 2025

(30) Foreign Application Priority Data
Oct. 20, 2022 (KR) 10-2022-0135916

(51) Int. Cl. H04N 1/34; H04N 1/00

(52) U.S. Cl. CPC H04N 1/346; H04N 1/00832

(57) ABSTRACT

A method can include receiving an image and acquiring coverage information regarding the image by calculating, for the image, a mono coverage value, a color coverage value, or both. The method can include generating, based on the coverage information, a coverage class and determining, based on the generated coverage class, a coverage class of a printout.

### BACKGROUND

There are different types of image forming apparatuses, including dedicated printers, scanners, photocopiers, facsimile machines, etc., and multi-function products (MFPs). An MFP acts as an all-in-one solution to provide a combination of, e.g., print, photocopy, scan, and fax functions.

An image forming apparatus may provide, e.g., for the purpose of billing a user for its use, data associated with usage of its monochrome toner or its color toner. Billing of the user may be done by the image forming apparatus classifying the usage amount data into a coverage class.

### BRIEF DESCRIPTION OF THE DRAWINGS

FIG. 1 is a diagram illustrating an example system that determines a coverage class consistent with the disclosure.

FIG. 2 is a diagram illustrating an example process of acquiring coverage information consistent with the disclosure.

FIG. 3 is a diagram illustrating an example of indicating coverage classes on a user interface consistent with the disclosure.

FIG. 4 is a diagram illustrating an example where there is received from a user an input that requests a coverage class change consistent with the disclosure.

FIG. 5 is a diagram illustrating an example of indicating coverage classes on the user interface when separate billing is to be done for a particular image consistent with the disclosure.

FIG. 6 is a diagram illustrating an example where there is received from the user an input that requests a coverage class change consistent with the disclosure.

FIG. 7 is a diagram illustrating an example of indicating, on the user interface, billing information regarding printouts consistent with the disclosure.

FIG. 8 is a flow diagram illustrating an example of a method for determining a coverage class consistent with the disclosure.

FIG. 9 is a schematic illustration of a computer readable recording medium including example instructions consistent with the disclosure.

### DETAILED DESCRIPTION

In some examples where a user uses an image forming apparatus to carry out a scan job, a print job, etc., an image forming apparatus may provide, for the purpose of billing the user for its use, data associated with costs based on usage of its monochrome toner or its color toner.

Such billing of the user may be done by the image forming apparatus classifying the usage amount data into a coverage class. In some examples, if based on a coverage class predetermined for the image forming apparatus, the billing of the user may result in applying a billing scheme that is not suitable for an environment where the image forming apparatus is in use by the user.

For example, a document may be mapped to a color coverage class if the document contains a particular image including a small color pattern such as a company logo image. In this example, frequent printing of documents including the company logo image may create a greater expense in the printing, as compared to printing of monochrome documents. In such examples a user may prefer classification of a particular type of printout as a particular coverage class and application thereto of a different billing scheme.

Examples consistent with the disclosure can enable flexible setting of a coverage class in accordance with an individual user's usage. For instance, a user can flexibly set a coverage class with a particular coverage range.

Terms used in the present disclosure are chosen from a terminology in consideration of their function herein, which may be appreciated differently. In some instances, terms can be ascribed their meanings as set forth in detail in the detailed description. Accordingly, the terms used herein are defined consistently with their meanings in the context of the present disclosure, rather than simply by their names.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For example, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including one of an item or a plurality of the items.

The term “image forming job” as used herein may encompass an image-related job that involves an operation of forming an image and/or other processing operations, e.g., generation, storage, and/or transfer of an image file. The term “job” as used herein may encompass a chain of processes that facilitate an image forming job, as well as the image forming job per se. The expression “an image forming job performed by an image forming apparatus” may indicate a job related to printing, photocopying, scanning, facsimile, storage, transmission, coating, etc. Other types of jobs are also contemplated.

The term “image forming apparatus” as used herein may encompass any of a variety of devices, such as a printer, a scanner, a facsimile machine, an MFP, a display device, etc., that perform an image forming job. In some examples, an image forming apparatus may be a two-dimensional (2D) or three-dimensional (3D) image forming apparatus. Such image forming apparatus may provide various additional functions such as print, photocopy, and scan functions.

The terms “electronic device,” “electronic apparatus,” or “user device” as used herein may refer to any information processing device, such as, for example, a computer, a laptop, a table PC, a mobile telephone terminal, etc. that may be used by a user.

The term “host device” may mean a device that can be connected with an image forming apparatus to control functions of the image forming apparatus. For example, a host device may include any of an electronic device, an electronic apparatus, a user device, etc. that can be connected with an image forming apparatus in a wireless or wired manner.

The term “user” as used herein may refer to a person who, or an organization which, manipulates an image forming apparatus to operate an image forming job.

The term “administrator” as used herein may refer to a person who, or an organization which, has access to the entire functionality of an image forming device. For example, an administrator may be a person who, or an organization which, can use a remote management server to set environment configuration data for image forming apparatuses. In some examples, one person or organization may have both roles of an administrator and user.

The term “service provider” as used herein may refer to a person who, or an organization which, offers an image forming apparatus to a user and has control of the functions and settings of the image forming apparatus. By way of example and not limitation, a service provider may be a reseller who lends a plurality of image forming apparatuses to a particular user or group, applies device setting values of the plurality of image forming apparatuses according to an established contract, and controls and manages installation of an application and a setting value of the application. One person or organization may have both roles of a service provider and administrator.

Each of the terms “unit,” “module,” “engine”, etc. as used herein may refer to a unit to process a function or operation, which may be implemented as a hardware component, e.g., a processor or a circuit, a software component for execution by the hardware component, and/or a combination thereof.

Some examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure. It is contemplated that some of the individual features described in one of the drawings may be implemented independently from each other or in combination.

These and other features of the examples will become apparent from the following detailed description taken in conjunction with the accompanying drawings.

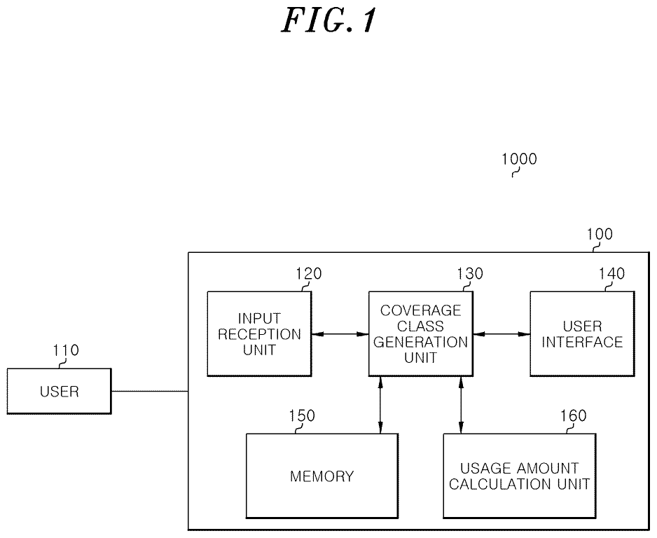

FIG. 1 is a diagram illustrating an example system 1000 that determines a coverage class consistent with the disclosure.

In some examples, the coverage class determination system 1000 may include an image forming apparatus 100 and a user 110. For example, the user 110 may be a person who, or an organization which, performs a scan job, a print job, etc. by using the image forming apparatus 100. Other examples of the user 110 are possible, including, for instance, an administrator or a service provider that bills another user for use of the image forming apparatus 100.

In an example, the image forming apparatus 100 may receive an image from the user 110 and generate a coverage class based on the image.

As shown in FIG. 1, the image forming apparatus 100 may include an input reception unit 120, a coverage class generation unit 130, a user interface 140, a memory 150, and a usage amount calculation unit 160. In FIG. 1, these components of the image forming apparatus 100 are illustrative. In some examples, the image forming apparatus 100 may also include an additional component such as a general-purpose component.

The input reception unit 120 may receive an image. As an example of the image, there may be received an image based upon which coverage classes are then generated.

The coverage class generation unit 130 may acquire coverage information regarding the image by calculating, for the image, a mono coverage value and/or a color coverage value. A coverage is a value that indicates how much area of a whole surface of a printout is covered with toner or ink. For example, the mono coverage value may indicate how much area of the whole surface of the printout is covered with monochrome toner. Similar, the color coverage value may indicate how much area of the whole surface of the printout is covered with color toner.

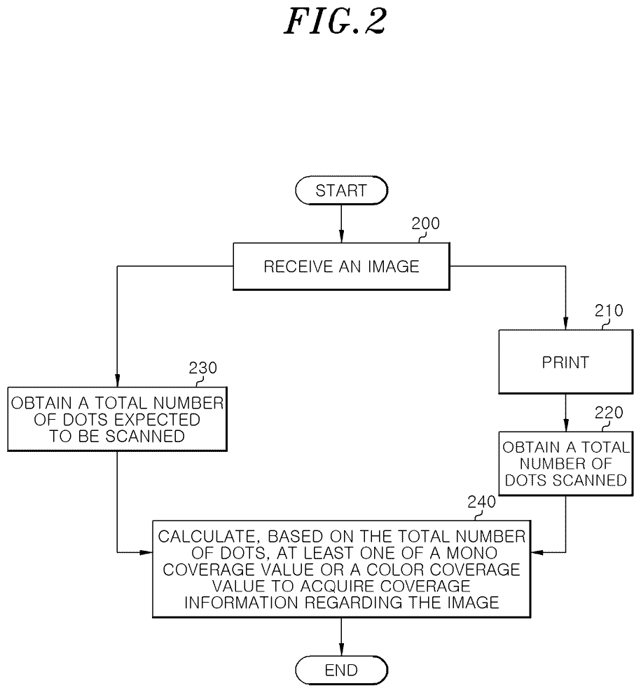

FIG. 2 is a diagram illustrating an example process of acquiring coverage information consistent with the disclosure.

As shown in FIG. 2, at 200, the input reception unit (e.g., input reception unit 120 in FIG. 1) may receive an image.

For example, the image may be an image file downloaded by the user through an apparatus that is external to the image forming apparatus (e.g., image forming apparatus 100 in FIG. 1) or may be an image file uploaded directly by the user. The image forming apparatus may include a print engine. For instance, at 210, the coverage class generation unit (e.g., coverage class generation unit 130 in FIG. 1) may use the print engine to print the image received from the user.

After the printing, at 220, the coverage class generation unit may obtain a total number of scanned dots through a video processing unit (VPU).

In some examples, the image may be data for printing or a scan image of a printout. The data for printing may be an image file downloaded by the user through an apparatus that is external to the image forming apparatus 100 or may be an image file uploaded directly by the user. Other examples of the data for printing are also possible. In some examples, the scan image of the printout may be a scan image produced using a scanner included in the image forming apparatus or may be a scan image produced using an external apparatus. At 230, the coverage class generation unit may obtain a total number of dots expected to be scanned when the image is image-processed and printed.

At 240, the coverage class generation unit may calculate, based on the obtained total number of dots, a mono coverage value and/or a color coverage value to acquire the coverage information.

Referring back to FIG. 1, the coverage class generation unit 130 may generate a coverage class based on the acquired coverage information. Further, the coverage class generation unit 130 may indicate the generated coverage class on the user interface 140.

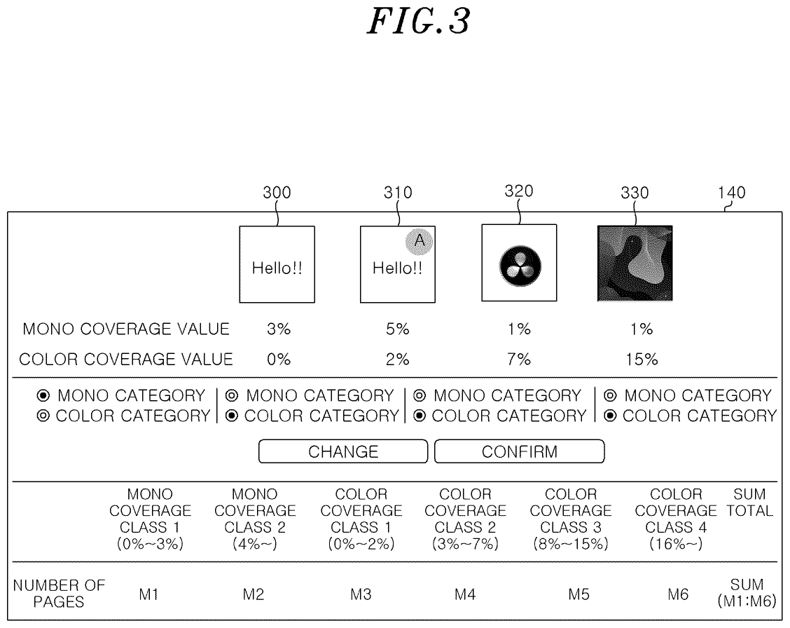

FIG. 3 is a diagram illustrating an example of indicating coverage classes on the user interface 140 consistent with the disclosure.

In an example, the coverage class generation unit (e.g., coverage class generation unit 130 in FIG. 1) may determine, and indicate on the user interface 140, whether the image received from the input reception unit (e.g., input reception unit 120 of FIG. 1) falls into a mono category or a color category. Further, the coverage class generation unit may generate, based on the acquired coverage information and whether the image falls into the mono category or the color category, and also indicate on the user interface 140, a mono coverage class corresponding to a range of particular mono coverage values or a color coverage class corresponding to a range of particular color coverage values.

FIG. 3 illustratively depicts an example screen that can be indicated on the user interface 140 when the example images are received from the input reception unit: including, for example a mono image 300 and/or three different color images 310, 320, and 330. Put another way, the coverage class generation unit may determine, and indicate on the user interface 140, that the one mono image 300 falls into the mono category and that the three different color images 310, 320, and 330 fall into the color category.

Further, the coverage class generation unit may indicate coverage information acquired for each of the one mono image 300 and the three different color images 310, 320, and 330. For example, it may be indicated that: for the mono image 300, the mono and the color coverage values are 3% and 0%, respectively; for the first color image 310, the mono and the color coverage values are 5% and 2%, respectively; for the second color image 320, the mono and the color coverage values are 1% and 7%, respectively; and for the third color image 330, the mono and the color coverage values are 1% and 15%, respectively.

For each of the images, the coverage class generation unit may generate, based on the coverage information and whether that image falls into the mono category or the color category, and indicate on the user interface 140, a mono coverage class or a color coverage class.

For example, the coverage class generation unit may generate N+1 mono coverage classes if N ones of the images fall into the mono category and may generate M+1 color coverage classes if M ones of the images fall into the color category. Other examples are also possible.

For example, assuming that N ones of the images fall into a same one of the mono and the color categories with their N corresponding coverage values c1, c2, . . . , cn in ascending order, there may be generated N+1 coverage classes corresponding to their respective ranges of integer-type or real-type coverage values, as illustrated in Table 1. Other examples are also possible.

TABLE 1

| | Range of integer-type coverage | Range of real-type coverage |
|---|---|---|
| | values | values |
| Coverage Class 1 | 0 ≤ Coverage Value ≤ c1 | Coverage Value ≤ c1 |
| Coverage Class 2 | (c1 + 1) ≤ Coverage Value ≤ c2 | c1 < Coverage Value ≤ c2 |
| . . . | . . . | . . . |
| Coverage Class N + 1 | Coverage Value ≥ (cn + 1) | Coverage Value > c2 |

Accordingly, in the example illustrated in FIG. 3, the number of generated mono coverage classes is two in total, such that Mono Coverage Class 1 has a range of integer-type mono coverages value from 0% to 3% and Mono Coverage Class 2 has a range of integer-type mono coverage values greater than or equal to 4%. In the example, the number of generated color coverage classes is four in total, such that Color Coverage Class 1 has a range of integer-type color coverage values from 0% to 2%, Color Coverage Class 2 has a range of integer-type color coverage values from 3% to 7%, Color Coverage Class 3 has a range of integer-type color coverage values from 8% to 15%, and Color Coverage Class 4 has a range of integer-type color coverage values greater than or equal to 16%.

Any of the mono and the color coverage classes generated as mentioned above may be indicated on the user interface 140 with its corresponding range of the particular mono and color coverage values. When desiring to confirm the indicated coverage class without making any changes thereto, the user (e.g., user 110 in FIG. 1) may select the indicated object with the button “Confirm.” When desiring to change the indicated coverage class, the user may select the indicated object with the button “Change.”

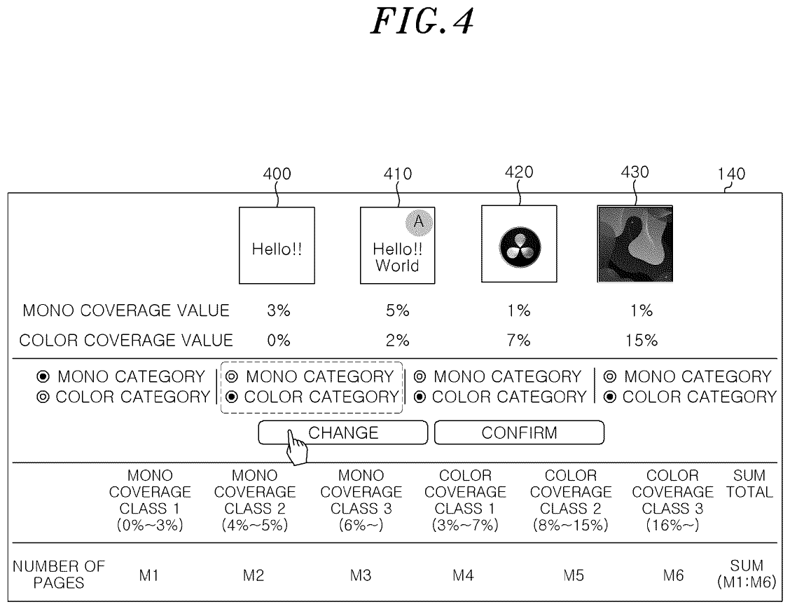

FIG. 4 is a diagram illustrating an example where there is received from a user an input that requests a coverage class change consistent with the disclosure.

In some examples, when receiving from the user (e.g., user 110 in FIG. 1) an input to change the category of the received image to the mono category or to the color category, the coverage class generation unit (e.g. coverage class generation unit 130 in FIG. 1) may update based on the received input, and indicate on the user interface 140, the generated coverage class.

In some examples, the input received from the user may include an input to change a category of a first image from the color category to the mono category and the coverage class generation unit may update based on a first color coverage value of the first image with the category thereof changed, and indicate on the user interface 140, the generated coverage class.

In this example, the coverage class generation unit may update the coverage class in a manner to generate a first color coverage class corresponding to a range of color coverage values greater than the first color coverage values without generating a color coverage class corresponding to a range of color coverage values smaller than or equal to the first color coverage values and may indicate the updated coverage class on the user interface 140.

As with FIG. 3, FIG. 4 illustratively depicts an example screen that is indicated on the user interface 140 when the example images are received from the input reception unit 120 including one mono image 400 and three different color images 410, 420, and 430. In the example of FIG. 4, the input can be received from the user to change the category of the first color image 410, which has a smallest color coverage value, from the color category to the mono category.

Accordingly, in the example, the total number of images falling into the mono category is two and, hence, three mono coverage classes are generated such that Mono Coverage Class 1 has a range of integer-type mono coverage values from 0% to 3%, Mono Coverage Class 2 has a range of integer-type mono coverage values from 4% to 5%, and Mono Coverage Class 3 has a range of integer-type mono coverage values greater than 6%. Further, in the example, the total number of images falling into the color category is two and, hence, four color coverage classes are generated such that Color Coverage Class 1 has a range of integer-type color coverage values from 3% to 7%, Color Coverage Class 2 has a range of integer-type color coverage values from 8% to 15%, and Color Coverage Class 3 has a range of integer-type color coverage values greater than or equal to 16%.

This example shows that the generated coverage classes may be updated in a manner where the first color coverage class, e.g., Color Coverage Class 1, is generated corresponding to a range of 3% to 7%, which range exceeds 2%, e.g., the color coverage value for the first color image 410 with the category thereof changed, and no coverage class is generated corresponding to a range of color coverage values smaller than or equal to 2%. In such an example, a color printout of an image having a color coverage value smaller than or equal to 2% can be classified as Mono Coverage Class 3, which corresponds to the range of greater than 6%. Therefore, in such examples, a printout that contains a particular image including a smaller color pattern such as a company logo image may not be unconditionally classified as a color coverage class and may instead be classified as a mono coverage class so that a different billing scheme may be applied thereto.

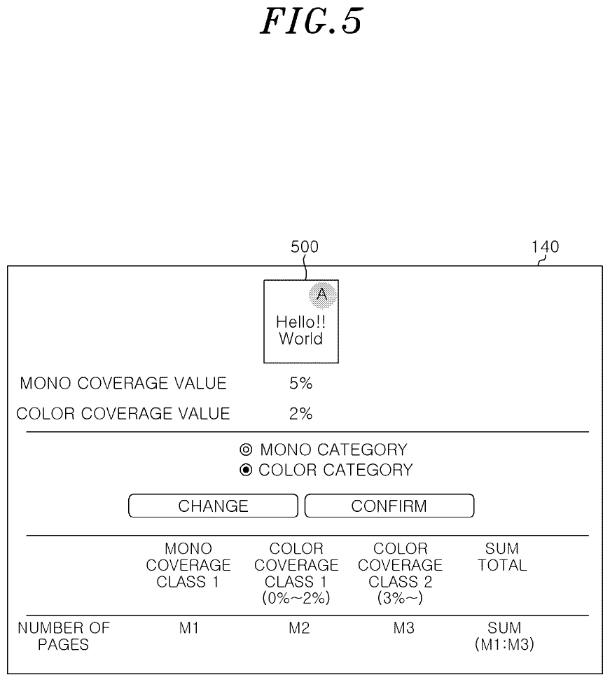

FIG. 5 is a diagram illustrating an example of indicating coverage classes on the user interface 140 when separate billing is to be done for a particular image consistent with the disclosure.

FIG. 5 illustratively depicts an example screen that is indicated on the user interface 140 when one color image 500 is received from the input reception unit (e.g., input reception unit 120 of FIG. 1). For example, when separate billing is to be done for a particular image including a smaller color pattern such as a company logo image, the user may input the particular image to generate a coverage class.

In some examples, the one-color image 500 may be set as falling into the color category. Accordingly, the total number of images falling into the mono category may be zero and, hence, one mono coverage class may be generated such that Mono Coverage Class 1 has a range of mono coverage values, e.g., a range of all possible mono coverage values, which may not be indicated. In some examples, the total number of images falling into the color category is one and, hence, two color coverage classes are generated such that Color Coverage Class 1 has a range of integer-type color coverage values from 0% to 2% and Color Coverage Class 2 has a range of integer-type color coverage values greater than or equal to 3%.

In some examples, this can allow for classifying a printout that contains a particular image, including a smaller color pattern such as a company logo image, as Color Coverage Class 1 and applying thereto a different billing scheme.

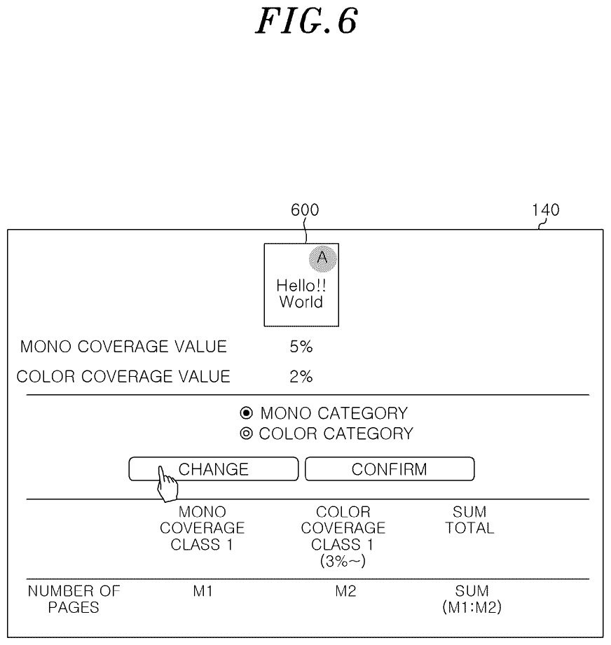

FIG. 6 is a diagram illustrating an example where there is received from the user an input that requests a coverage class change consistent with the disclosure.

As with FIG. 5, FIG. 6 illustratively depicts an example screen that is indicated on the user interface 140 when one color image 600 is received from the input reception unit (e.g., input reception unit 120 of FIG. 1). In the example of FIG. 6, the input can be received from the user (e.g., user 110 in FIG. 1) to change a category of the one-color image 600 from the color category to the mono category.

In some examples, the generated coverage classes may be updated in a manner where the first color coverage class, e.g., Color Coverage Class 1, can be generated corresponding to a range of greater than 3%, which exceeds 2%, e.g., the color coverage value for the one color image 600 with the category thereof changed and that no coverage class is generated corresponding to a range of color coverage values smaller than or equal to 2%. In such examples, a color printout of an image having a color coverage value smaller than or equal to 2% can be classified as Mono Coverage Class 1, which corresponds to the range of all possible mono coverage values.

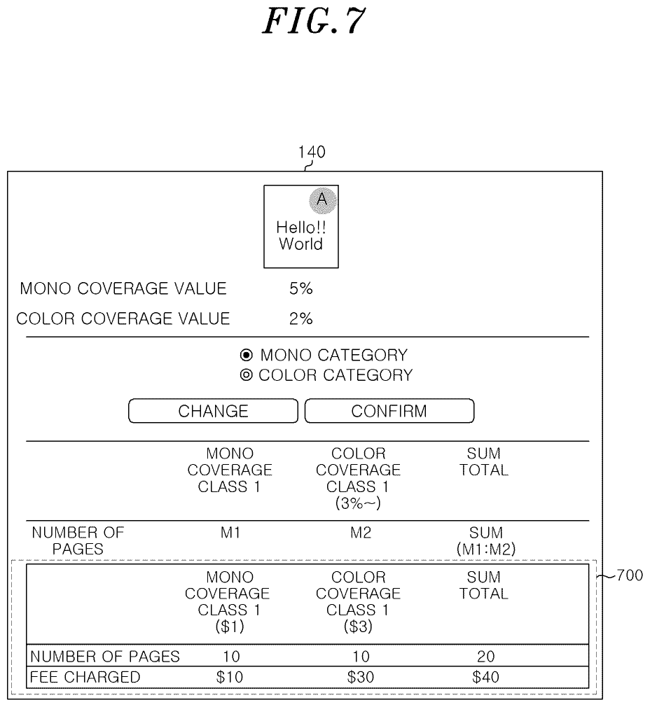

FIG. 7 is a diagram illustrating an example of indicating, on the user interface 140, billing information regarding printouts consistent with the disclosure.

In some examples, the coverage class generation unit (e.g., coverage class generation unit 130 of FIG. 1) may perform classification by determining, based on the generated coverage class, coverage classes of already-printed printouts and may generate in accordance with the classification, and indicate on the user interface 140, billing information regarding the already-printed printouts.

FIG. 7 illustratively depicts an example screen that is indicated on the user interface 140 when the billing information regarding the already-printed printouts is simulated based on the coverage classes generated in the example of FIG. 6 consistent with the disclosure.

For example, when there are twenty already-printed printouts, ten of which are color printouts having color coverage values of 2%, and the remaining of which are mono printouts, the coverage class generation unit (e.g., coverage class generation unit 130 of FIG. 1) may generate based on the coverage classes generated in the example of FIG. 6, and indicated on the user interface 140, simulated billing information 700.

In some examples, simulating the billing information regarding the already-printed printouts based on the generated coverage classes and indicating the simulated billing information may assist the user (e.g., user 110 of FIG. 1) in determining whether to confirm the generated coverage classes.

Referring again to FIG. 1, when the input is received from the user 110 to confirm the generated coverage class(es) as described above with respect to FIGS. 2 to 7, the generated coverage class(es) may be stored in the memory 150.

The memory 150 may be implemented in hardware to store a variety of data to be processed in the image forming apparatus 100, for example, programs for processing and control of its processor.

In some examples, the memory 150 may be implemented with Random Access Memory (SRAM), such as Dynamic Random Access Memory (DRAM), Static Random Access Memory (SRAM), or the like, Read-Only Memory (ROM), Electrically Erasable Programmable Read-Only Memory (EEPROM), CD-ROM, Blu-ray or other optical disc storage, Hard Disk Drive (HDD), Solid State Drive (SSD), flash memory, etc.

In some examples, the usage amount calculation unit 160 may determine, based on the stored coverage class(es), a coverage class of a printout. For example, whenever printing is carried out after the confirmation and storage of the coverage class(es), the usage amount calculation unit 160 may determine, based on a mono coverage value and/or a color coverage value of the printout, the coverage class of the printout. In some examples, the usage amount calculation unit 160 may calculate a total accumulated number of pages of printouts per stored coverage class.

Each of the input reception unit 120, the coverage class generation unit 130, and the usage amount calculation unit 160 can include a unit that processes a function or operation and may be implemented as a hardware component, e.g., a processor or a circuit, a software component for execution by the hardware component, and/or a combination thereof, as apparent to those skilled in the art. In some examples the function or operation may not be performed by that specific unit of the illustrated apparatus. In some instances, these units may not be physically separate from one another, and various ones of the units may be combined into a single or multiple modules. The processor of the image forming apparatus 100 may control the overall functionality of the image forming apparatus 100, in some instances. For example, the processor may control some operations of the image forming apparatus 100 by executing programs (e.g., machine-readable instructions) stored in the memory 1020.

The processor may be implemented using, for example, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, and/or other electrical units.

Although not shown in FIG. 1, the image forming apparatus 100 may include a communications unit. The communications unit may include one or more components to enable the image forming apparatus 100 to communicate wirelessly and/or in a wired manner. For example, the communications unit may include a short-range communications unit (not shown), a mobile communications unit (not shown), and/or a broadcast receiver unit (not shown).

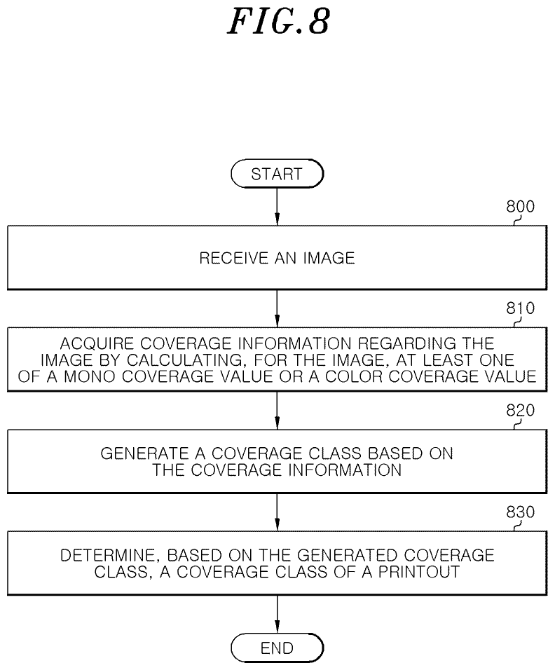

FIG. 8 is a flow diagram illustrating an example of a method for determining a coverage class consistent with the disclosure.

At 800, the image forming apparatus (e.g., image forming apparatus 100 of FIG. 1) may receive an image.

At 810, the image forming apparatus may acquire coverage information regarding the image by calculating, for the image, a mono coverage value and/or a color coverage value.

For example, the image forming apparatus may print out the image to obtain a total number of dots scanned and may calculate, based on the total number of dots scanned, the mono coverage value and/or the color coverage value to acquire the coverage information.

In some examples, the image forming apparatus may scan the image to obtain a total number of dots expected to be scanned and may calculate, based on the total number of dots expected, the mono coverage value and/or the color coverage value to acquire the coverage information.

At 820, the image forming apparatus may generate a coverage class based on the coverage information.

For example, the image forming apparatus may determine, and indicate on the user interface, whether a category of the image is a mono category or a color category. The image forming apparatus may generate, based on the coverage information and whether the category of the image is the mono category or the color category, and indicate on the user interface, a mono coverage class corresponding to a range of particular mono coverage values or a color coverage class corresponding to a range of particular color coverage values.

For example, the image forming apparatus may receive, from the user, an input to change the category of the image to the mono category or to the color category and may update based on the received input, and indicate on the user interface, the generated coverage class.

For example, the input received from the user may include an input to change a category of a first image from the color category to the mono category, and the image forming apparatus may update based on a first color coverage value of the first image with the category thereof changed, and indicate on the user interface (e.g., user interface 140), the generated coverage class.

For example, the image forming apparatus may perform classification by determining, based on the generated coverage class, coverage classes of already-printed printouts and may generate in accordance with the classification, and indicate on the user interface, billing information regarding the already-printed printouts.

At 830, the image forming apparatus may determine, based on the generated coverage class, a coverage class of a printout.

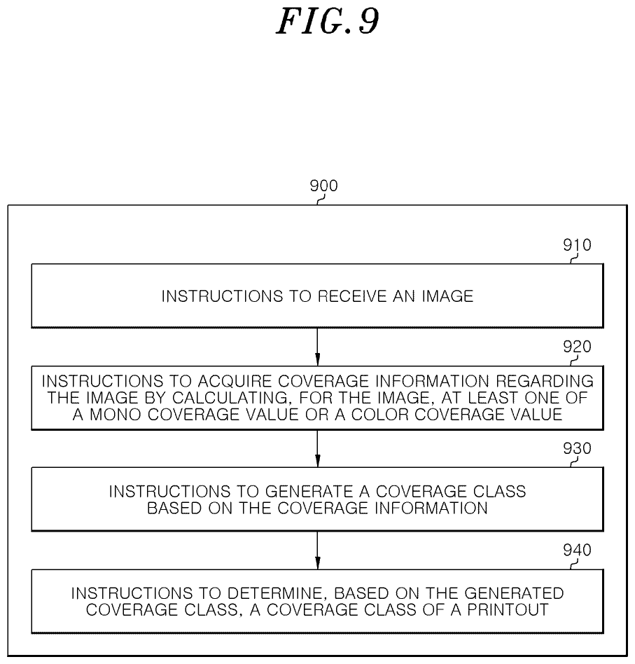

FIG. 9 is a schematic illustration of a computer readable recording medium including example instructions consistent with the disclosure.

In some examples, a computer readable recording medium 900 can store a computer program (e.g., machine-readable instructions) that is executable by a processor and programmable to implement operations of the aforementioned methodology. The computer program on the computer readable storage medium 900 may include a set of program instructions that direct the processor to perform specific operations.

In some instances, the computer program includes instructions that when executed by a processor of a computer, cause the processor to perform operations. For example, the instructions may include instructions 910 executable to receive an image, and instructions 920 executable to acquire coverage information regarding the image by calculating, for the image, a mono coverage value and/or a color coverage value. The instructions may include instructions 930 executable to generate, based on the coverage information, a coverage class and instructions 940 executable to determine, based on the generated coverage class, a coverage class of a printout.

The above-described computer readable recording medium 900 may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In some examples, the methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, a portion of the computer program product may be temporarily stored, or temporarily created, in a storage medium such as a memory of a server of the manufacturer, a server of the application store, or a relay server.

The foregoing description has been presented to illustrate and describe some examples in detail. modifications and variations are possible in light of the above teaching. In some examples, suitable results may be achieved if the above-described techniques are performed in a different order, and/or if some of the components of the above-described systems, architectures, devices, circuits, etc. are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. An apparatus, comprising:
a memory to store instructions; and
a processor, wherein when executed, the instructions cause the processor to:
receive an image;
acquire coverage information regarding the image by calculating, for the image, a mono coverage value, a color coverage value, or both;
generate a coverage class based on the coverage information; and
determine, based on the generated coverage class, a coverage class of a printout.

2. The apparatus of claim 1, wherein the apparatus comprises a print engine, and wherein when executed, the instructions cause the processor to:
obtain a total number of dots scanned when the image is printed using the print engine; and
acquire the coverage information by calculating, based on the total number of dots scanned, the mono coverage value, the color coverage value, or both.

3. The apparatus of claim 1, wherein the apparatus comprises a print engine, wherein the image comprises data for printing or a scan image of a printout, and wherein when executed, the instructions cause the processor to:
obtain a total number of dots expected to be scanned when the image is printed using the print engine; and
acquire the coverage information by calculating, based on the total number of dots expected, the mono coverage value, the color coverage value, or both.

4. The apparatus of claim 1, wherein when executed, the instructions cause the processor to:
determine, and indicate on a user interface, whether a category of the image is a mono category or a color category; and
generate based on the coverage information and whether the category of the image is the mono category or the color category, and indicate on the user interface, a mono coverage class corresponding to a range of mono coverage values or a color coverage class corresponding to a range of color coverage values.

5. The apparatus of claim 4, wherein when executed, the instructions cause the processor to:
receive, from a user, an input to change the category of the image to the mono category or to the color category; and
update based on the received input, and indicate on the user interface, the generated coverage class.

6. The apparatus of claim 5, wherein the input received from the user comprises an input to change a category of a first image from the color category to the mono category, and wherein when executed, the instructions cause the processor to:
update, based on a first color coverage value of the first image with the category thereof changed, and indicate on the user interface, the generated coverage class.

7. The apparatus of claim 1, wherein when executed, the instructions cause the processor to:
perform classification by determining, based on the generated coverage class, coverage classes of already-printed printouts; and
generate in accordance with the classification, and indicate on the user interface, billing information regarding the already-printed printouts.

8. A method, comprising:
receiving an image;
acquiring coverage information regarding the image by calculating, for the image, a mono coverage value, a color coverage value, or both;
generating a coverage class based on the coverage information; and
determining, based on the generated coverage class, a coverage class of a printout.

9. The method of claim 8, wherein acquiring the coverage information comprises:
obtaining a total number of dots scanned when the image is printed; and
acquiring the coverage information by calculating, based on the total number of dots scanned, the mono coverage value, the color coverage value, or both.

10. The method of claim 8, wherein the image comprises data for printing or a scan image of a printout, and wherein acquiring the coverage information comprises:
obtaining a total number of dots expected to be scanned when the image is printed; and
acquiring the coverage information by calculating, based on the total number of dots expected, the mono coverage value, the color coverage value, or both.

11. The method of claim 8, wherein generating the coverage class comprises:
determining, and indicating on a user interface, whether a category of the image is a mono category or a color category; and
generating, based on the coverage information and whether the category of the image is the mono category or the color category, and indicating on the user interface, a mono coverage class corresponding to a range of mono coverage values or a color coverage class corresponding to a range of color coverage values.

12. The method of claim 11, wherein generating the coverage class comprises:
receiving, from a user, an input to change the category of the image to the mono category or to the color category; and
updating based on the received input, and indicating on the user interface, the generated coverage class.

13. The method of claim 12, wherein the input received from the user comprises an input to change a category of a first image from the color category to the mono category, and wherein the indicating comprises:
updating, based on a first color coverage value of the first image with the category thereof changed, and indicating on the user interface, the generated coverage class.

14. The method of claim 8, wherein the indicating comprises:
performing classification by determining, based on the generated coverage class, coverage classes of already-printed printouts; and
generating in accordance with the classification, and indicating on the user interface, billing information regarding the already-printed printouts.

15. A computer readable recording medium having stored therein machine-readable instructions that when executed by a computer, causes the computer to:
receive an image;
acquire coverage information regarding the image by calculating, for the image, a mono coverage value, a color coverage value, or both;
generate a coverage class based on the coverage information; and
determine, based on the generated coverage class, a coverage class of a printout.
